(19) United States
(12) Patent Application Publication
(10) Pub. No.: US 2007/0122279 A1
(43) Pub. Date: May 31, 2007

(54) Water Wall Turbine

(76) Inventors: Marek Andrzej Sredzki, Lions Bay, BC (CA); Lodewyk Michael Botha, Johannesburg (ZA)

Correspondence Address: MAREK A. SREDZKI, BOX 235, 260 OCEANVIEW ROAD, LIONS BAY, BC, V0N-2E0, CA

(21) Appl. No.: 11/464,199

(22) Filed: Aug. 13, 2006

(30) Foreign Application Priority Data
Aug. 18, 2005 (ZA) 2005/1445
May 11, 2006 (CA) 2 546 897

(51) Int. Cl. F03B 17/06

(52) U.S. Cl. 416/84

(57) ABSTRACT

The Water Wall Turbine is a turbine device that consists of blades, cables, shaft, and sometimes flotation sections in the Blades for small (from under 1 KW) to large (multi MW) scale Energy Extraction (Potential and Kinetic) from currents, and to convert this Energy into Mechanical Energy for further conversion into Electrical Energy. The Water Wall Turbine is designed for Renewable Energy Generation in the best Eco- and Bio-friendly way by making Barrages redundant through its large blades that move almost at the same speed as the Current. The Water Wall Turbine is a Cylindrical structure that is less than 50% submerged into the current and is designed to harvest the Energy, made available by the Head induced across the Blades, by the Blades, that restrictively rotate slower than the Current during the extraction of Energy from the current.

### FIELD OF THE INVENTION

This invention relates to Turbines for the Extraction of Energy from Currents, to be available for conversion into Electrical Energy.

The Invention further also relates to Renewable Energy Generation in a near 100% Eco- and Bio-friendly way.

The Invention further relates to small to large scale Renewable Energy Generation in an Economical way.

Comparing Energy Sources' advantages/disadvantages on the Environment with existing Technologies:

| | Eco- | Bio- | Negative | Negative |
|---|---|---|---|---|
| | Friendliness | Friendliness | Impact of | Impact |
| | During | During | Construction | During |
| Technology | Operation | Operation | Phase | Operation |
| Solar | Extremely | Extremely | Minimal | Minimal |
| Wind | Very | Reasonable | Minimal | Minimal |
| Land Hydro | Poor | Extremely Poor | Enormous | Enormous |
| Barrages | | | | |
| Tidal | Poor | Poor | Large | Enormous |
| Sea Currents | Poor | Extremely Poor | Minimal | Enormous |
| W W Turbine | Extremely | Extremely | Minimal | Minimal |

### BACKGROUND OF THE INVENTION

The search has forever been going on for the development of systems that could make the dreams of Economical large scale Renewable Energy Generation, and specifically Eco-friendly Energy Generation, a reality.

Presently, only Energy producing units such as Solar and Wind seems to be really Eco-friendly and world wide applicable although their Energy Production per m² is somewhat low.

Geothermal has its massive Eco- and Bio-friendly features but its availability with present technology is limited to a few isolated spots around the globe.

Water though, with about a 1000 times advantage over wind at the same speed, seems to be the most logical medium to address in the serious search for Renewable Energy Generation.

Currently however, the only significant Hydro Electric Energy contributions come from large Hydro Electric schemes in dams in rivers, with their accompanying devastating impacts on the Environment in terms of:
1. Its destruction of habitat (Eco- and Bio-systems), in the areas that is flooded and under water,
2. Its displacement of Population from the areas,
3. Its destruction of Eco-systems along the whole river below the dam,
4. Its production of unacceptable quantities of Hothouse gasses such as CO2 as a result of rotting vegetation in the dams,
5. Its total prohibition on movement of all aquatic life that used to migrate up and down the river system,
6. Its destruction of virtually all non microscopic Animal life that passes through its Turbines.

Massive research has gone into ways to Economically Harvest Marine Current Energy and Wave Energy, but up to now their contributions to the Energy Needs of the World has been marginal.

In comparing Current Energy with Wave Energy, the following has been found:
1. There are more potential in Current Energy than in Wave Energy, but current Marine Turbines employed to Generate Energy from this source has limitations on their Blade lengths, their overall efficiencies, and therefore their Energy Output Potential.
2. Numerous of these Turbines will have to be positioned over a very large area in order to generate the same amount Energy as can be achieved with a few Water Wall Turbines in a fraction of the area.
3. These Marine turbines can also not very effectively be used for Energy Extraction from Tidal Currents whereas; the Water Wall Turbine is ideally suited for this application.

Solutions offered by this Invention (with and through its application in water):

The Water Wall Turbine, by moving away from the conventional Marine Turbine approach and design, that concentrates on Kinetic Energy Extraction, is offering through it's design, a system that can Extract Potential Energy from Currents.

This approach to Extract Potential Energy from Currents offers a unique solution to the conflicting problems of the above mentioned Renewable Energy Extraction systems such as Hydro Electrical with dams and Barrages, Solar, Wind, Geo-thermal, etc. in their main features of:
1. Energy Extraction and Production potential, their
2. Cost effectiveness, and
3. Negative effects on the environment.

The Water Wall Turbine further offers a solution, to all significant Marine and Hydro Electric Turbines that have their Turbine Shafts totally submerged and are experiencing water pressure sealing problems, in that the Water Wall Turbine, with its Shaft, Gearbox and Generator well above water level, has no water sealing problems.

The uniqueness of this Patent in its solutions to the above, lies in its approach to concentrate on the Extraction of Potential Energy from Currents, with the Blades rotating in, and with the Current whilst being less than 50% submerged.

The novelty, uniqueness, non-obviousness, high Energy Yield, and Eco- and Bio-friendliness of this Patent lies in the basic solutions offered by this Patent for effective Renewable Energy Extraction, with our design in the form of the Water Wall Turbine as follows:
1. Apply the Shaft horizontally above the water level and,
2. Apply the Shaft perpendicularly to the Current,
3. Apply the Shaft as described above to enable the blades to rotate “virtually in sync.” with the Current, with a small negative relative speed difference between the Water Wall Turbine blades and the water, resulting in absolute Eco- and Bio-friendly Renewable Energy Generation.

A further part of the Solution offered by the Water Wall Turbine in its application is that it will create its own Barrage effect due to the small negative relative speed difference between the Water Wall Turbine blades and the water, thus creating a “Head” across its Blades, providing Potential Energy for Extraction.

Another part of our solution is that we use:
1. Rotating Blades to create the Barrage effect, and
2. Cables, in one form or another, in some designs to transfer Forces due to the Extracted Energy, from the Blades to the Shaft to rotate the shaft.

The further solution offered by our design is the introduction of Cables for stability/strength enhancement of the superstructure of the Water Wall Turbine, making possible the design and construction of massive but relative light Water Wall Turbines.

The Superstructure, consisting of the Shaft, Blades and Cables (where applicable), can be designed along normal Engineering principles and Manufactured from Engineering practical materials.

The permutations of Water Wall Turbine Length to Diameter are endless:
1. If the diameter is small, it may be found that the inherent Blade structure strength is strong enough not to require cables, although the use of it will make for a much lighter design, without deviating from the basic premise of this Innovation which is to facilitate the forming of a “Head” across the Turbine, thereby making Potential Energy available for safe, Eco- and Bio-friendly Energy Extraction.
2. In the case of the small diameter Water Wall Turbines, more exotic Blade curves can be introduced.
3. The usefulness of this Patent is its ability to provide, economic viable large scale, pollution free, Eco- and Bio-friendly Renewable Energy.

The solution offered by the Water Wall Turbine allows for a Low Cost Turbine for Energy Extraction from Currents to be produced that would offer a low $/KW Installation cost.

The further solution offered with the Water Wall Turbine because of its potential to design large Turbines, is that a large part of a Current can be exploited at the same time, resulting in a large Energy Production and therefore a low $/KWh production cost.

### BRIEF SUMMARY OF THE INVENTION

1. It is therefore an object of this Invention to provide a method for the successful and efficient Energy Extraction from the Renewable Energy Source in Currents for the Generation of Electrical Energy.
2. It is a further object of this Invention to overcome the limitations in Energy Extraction capacity per Turbine as currently being experienced.
3. It is therefore a further object of this Invention to increase the Efficiency of Energy Extraction from Currents.
4. It is a further object of this Invention to overcome the disadvantages of current methods and ways to produce Large Quantities of Energy from the Renewable Energy Sources available in Currents.
5. It is a further object of this Invention to overcome the negative effect on the Environment, of current methods and ways to extract Large Quantities of Energy from Currents.
6. It is a further object of this Invention to provide a Turbine Design, where one Turbine effectively can replace numerous of the current Windmill type Marine Turbines in terms of Energy Extraction potential.
7. It is another object of this Invention to provide a way to overcome the destructive negative effect of the fast rotating Blades of the current Marine Turbines on Animal life.
8. It is another object of this Invention to provide a Renewable Energy Generating method to make redundant the need to build dams for new Hydro Electric Generating Systems in rivers.
9. Similarly it is further another object of this Invention to provide a Renewable Energy Generating method to make redundant the need to build Eco- and Bio-unfriendly Barrages in Estuaries and Tidal streams.
10. It is yet another object of this Invention to overcome most of the Size and weight restraints on the structure by incorporating and using Cables where necessary, to stabilize the Blades and Shaft structure that forms the Water Wall Turbine.
11. It is yet a further object of this Invention to provide an uncomplicated, cost effective, safe and reliable method to transfer the Power from the Blades to the Shaft, so as to be available for conversion into Electrical Energy.
12. It is another object of this Invention to simplify the Manufacturing of the Water Wall Turbine by means of modular pre-fabrication.
13. The further object offered with the Water Wall Turbine is that most of it can be constructed with low skilled workers.
14. The further solution and object offered with the Water Wall Turbine is that most of the components do not require costly high precision Engineering work.
15. It is a further object of this Invention is to provide the unique quick and non-invasive Construction and Installation features to ensure minimal Negative Environmental impact around the site during construction and commissioning by means of modular pre-fabrication of the Water Wall Turbine off site.
16. It is yet a further object of this Invention to provide a method to minimize the negative effect of large road making to provide for the transport of very large units, by making the modular construction of the unit possible, so it can be assembled on site.
17. It is a further object of this Invention to provide a simple and cost effective way of transporting the Module to the site by incorporating flotation devices in the Modular Blade/Shaft sections so they can be floated to their destination, to be assembled in situ with minimum Eco-damage.
18. It is yet another object of this invention to provide a design that will minimize the negative Ecological Effect during Energy Extraction and Generation from Tidal streams.
19. It is a further object of this Invention to provide a Design that will require much less time from conception to commissioning than any of the present comparable Power Station types.
20. It is yet a further object of this Invention to provide a Design for Construction that will be affordable in terms of Cost/kW.
21. It is an additional object of this Invention to provide a Design that can produce affordable Energy.
22. It is yet a further object of this Invention to provide a method to minimize the effect of the enormous weight of the large structures that has to be carried by bearings at the ends of the Shaft by means of Flotation sections in the Blades.
23. It is another object of this Invention to provide a Turbine with practical and easy maintenance facilities.

### BRIEF DESCRIPTION OF THE DRAWINGS

FIG. 1: This Figure shows an End View of a typical design of a Water Wall Turbine indicating Cables, Blades, and Shaft.

FIG. 2: This Figure shows a Side View of a Water Wall Turbine in FIG. 1.

FIG. 3: This Figure shows an Isometric View of a Water Wall Turbine, showing the Shaft and Blades without Cabling. It should be noted that Cabling will be employed as and when required by the design. The same goes for flotation sections in the Blades.

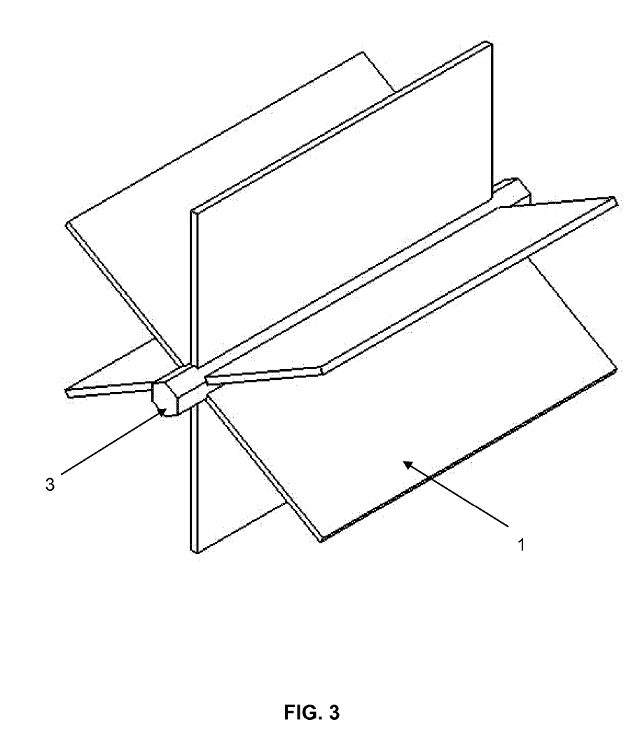

The embodiments of the invention in which an exclusive property or privilege is claimed are defined as follows:

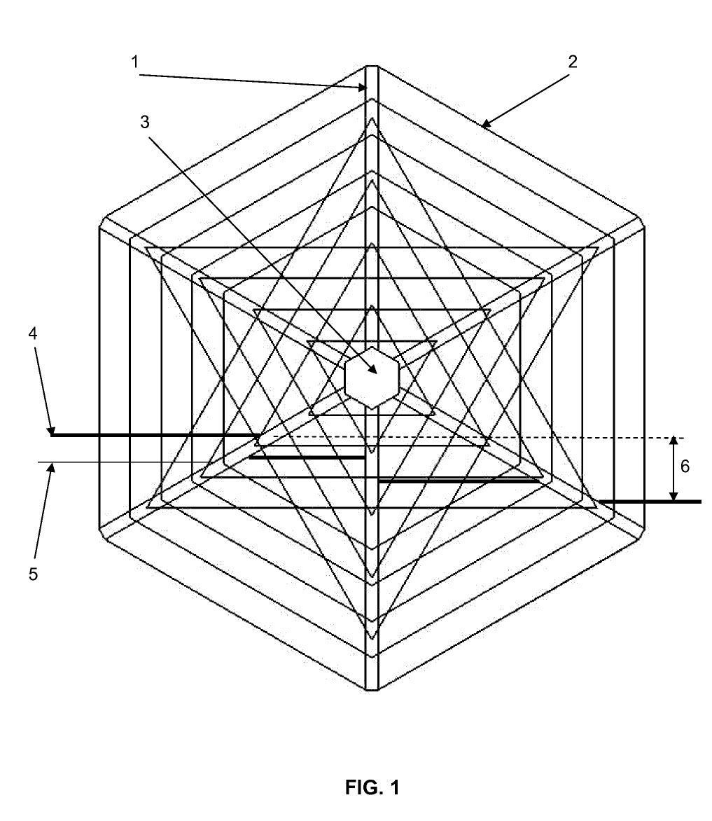

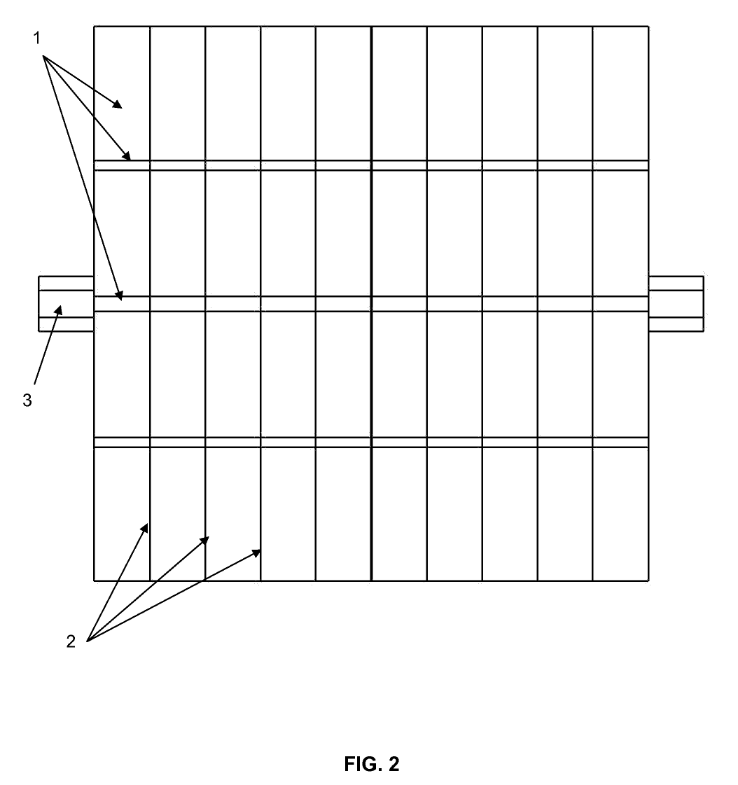

With reference to the drawings and, in particular, with reference to FIGS. 1 and 2, the Water Wall Turbine Construction consists of a Shaft 3, with radiating Blades 1 around it, and in some designs, be stabilized by Cables 2, and the Cables also act as instruments to transfer the Power extracted from the Current to the Shaft 3, as in cases where Cables are employed as required by the design.

The Water Wall Turbine is designed and constructed along normal sophisticated Engineering practices, and with the most practical materials.

The different elements of the Turbine can be constructed and/or fabricated from any Material that could effectively fulfill its purpose in an Engineering sense.

Glossary of numbers uses in Drawings:
1. Blade
2. Cables
3. Shaft
4. New Water levels example, after Heads has formed across the blades when
restricting the flow.
5. Normal Water level example, without the restrictive effect of the Blades.
6. Effective Head example, that formed as a result of the difference in water levels as described in Point 4 above.

### DETAILED DESCRIPTION OF THE INVENTION

The Water Wall Turbine is a novel method and design for the Extraction of Potential, as well as Kinetic Energy from a Current.

The Water Wall Turbine structure in the main consists of the Shaft and Blades, and sometimes as may be required by the design Cables, and Flotation sections in the Blades.

The Water Wall Turbine is designed and constructed along normal sophisticated Engineering practices, and with the most practical materials.

The Water Wall Turbine operates:
1. By means of a full Cross sectional and fontal “Attack” on the Current by the Blades,
2. By enabling the blades to rotate with the Current, resulting in high Energy Extraction from it,
3. By transferring this Power to the Shaft by means of Cables, when the design requires it, for conversion into Electrical Energy.

The Water Wall Turbine is designed to be absolutely Eco- and Bio-friendly by developing its own Barrage effect (the development of a Head across the Turbine) due to its physics, dimensions and operation.

The principles on which the Water Wall Turbine functions:

The Pressure difference across the Blades as a result of the “Head”, forces the Blades to move, and thus to rotate the Water Wall Turbine.

This pressure difference is the result of the Blades acting as restriction to the Current, causing a Head to form across the Blades. This Head represents the Potential Energy Force that is hydraulically propagated across the submerged Blade area.

The Water Wall Turbine utilizes the features of water to convert the Current Kinetic Energy, virtually lossless, into Potential Energy, and vice versa, therewith allowing the Current to build up behind its Blades (like water behind a dam wall) to be available as Potential Energy for harvesting.

In order to harvest this Energy, it must primarily, successfully and efficiently, be transferred from the water to the blades, and then to the shaft, in order to rotate the shaft for the Secondary process, namely the Conversion of this Power into Electrical Energy. This primary process is achieved by means of the Water Wall Turbine design.

The use of Cables in the Water Wall Turbine design to transfer the Forces on, and from the blades to the Shaft, enables the construction of relative light Turbines that can extract large quantities of Energy from Currents.

The way the Water Wall Turbine works:

The Water Wall Turbine consists of a shaft with a number of large Blades, joined to the Shaft, parallel to and along the length of the Shaft 3, and evenly distributed around the Shaft, and radiating outwards. (See FIG. 1 and FIG. 2)

The shaft is positioned Horizontal (in most cases), and perpendicular to the Current, with the bottom side of the Water Wall Turbine Blades immersed into the Current, and with the Shaft above the water level. (See FIG. 1)

The hydraulic pressure caused by the Head, against the blades, pushes and moves the blades, and adjacent Blades are continuously rotated into place, to replace the “previous” Blades in the Current, so as to “confront” the Current continuous, “like walls”, as they rotate around a Horizontal Axis, allowing for the “extraction of Energy” from Currents.

The Water Wall Turbine can operate in very deep waters, but the optimal performance, under similar Current speeds, will be under conditions where the Blades can successfully effect a restriction to the flow like a dam wall would, i.e. distance between floor and lowest path of blade tip should be as small as practical possible to develop the Maximum “Head” across the Turbine.

As a result of the small relative-speed difference between the Blades with Cables, and the water, cables can be used to supply Structural stability to these large Water Wall Turbine “Blades” without causing unacceptable “Resistance” losses during operation.

The structural stabilizing Cables of the Water Wall Turbine are simultaneously employed to transfer the Power, exerted by the Current and Current levels on the blades, to the shaft, for rotation.

The Construction of the Water Wall Turbine:

A typical Water Wall Turbine will consists of an shaft with a number of Longitudinal Blades radiating outwards along a length of the shaft, and in the case of larger Turbines, “Structural and Power Transferring” cabling. (See FIG. 1, FIG. 2)

The Blades may or may not be:
1. Only one side clad with a material such as Metal Sheeting, Glass fiber Sheeting, Woven material, or other suitable products, that will “strive” to prevent the Current from passing through it.
2. Clad, three dimensional, in order to form airtight sealed chambers that would serve as flotation devices as well as to enhance the rigidity and thus strengthen the structure.
3. Further strengthened and stabilized by means of the incorporation and employment of Cable stays, as and when required as per design.

Cables may or may not be employed for structural rigidity or the transfer of power to the shaft, depending on the requirements as per design and Materials used.

The shaft may or may not be part of the modular pre-fabrication of the Blades as and if required as per design.

The employment of cables for structural stability and transfer of Power to the Shaft makes possible the construction of massive but relative light Water Wall Turbines that can deliver vast quantities of Energy.

Large Water Wall Turbines would normally have as part of the reinforced pressure-bearing base of the blade, a section that serves as floatation device to neutralize most of the weight that would otherwise have to be borne by the bearings.

The difference between the Water Wall Turbine and conventional Marine Turbines:

A Water Wall Turbine can be massive and can replace numerous conventional Marine Current Turbines at a time.

A Water Wall Turbine will need a fraction of the effective sq km, or Current cross section required for Conventional Marine Turbine deployment, for the same Power output.

The Rotation speed of the Water Wall Turbine is typically under 1 rpm compared to the order of 10 to 20 rpm of Current Marine Turbines.

The Water Wall Turbine Blade tip speed relative to the water speed is actually slightly negative, but for all practical purposes we can approach it as 0 (zero), compared to ±15 m/s Blade tip speed, relative to water speed, of Current Marine Turbines.

Because of this blade movement, virtually in synch with the water movement, there is a very small “relative movement” between the Water Wall Turbine Blades, Cables and the water, and this feature makes the use of cables, to allow the Design and construction of “Very Large” but relative light Turbines.

The sealing problems against seawater penetration at around 2 to 3 Bar into the Drive train of Current Marine Turbines are absent in the Water Wall Turbine where everything is well above sea level at zero pressure.

The shaft of the Water Wall Turbine is perpendicular to the Current direction, whereas the conventional Marine Turbine shaft is parallel to the Current direction.

A Water Wall Turbine can be used in Tidal Currents of depths that vary at Low tide from 0 m (Zero meters) to High Tide of 17 m and more, whereas Marine Turbines only will work with special adaptations to the terrain to ensure that the whole Turbine is constantly submerged with the result that Current speed will have to be sacrificed.

The Manufacturing of the Water Wall Turbine:

The Water Wall Turbine can be produced in modular form using practical materials.

Each module of a large Turbine can, typically consist of one blade and one sector of the shaft.
1. This Blade module, will most probably have its own flotation section as part of its structure to overcome weight problems with large Water Wall Turbines and:
2. In the case of smaller Turbines, the Blades will still be Modular but the Shaft may also be a prefabricated module.

The Modules can be floated or transported over land to the final destination, assembled and positioned in situ, or

The Water Wall Turbine can be assembled at any comfortable site and, whichever method is preferable, floated or Transported to the final destination if allowed by the water depth en route.

The Maintenance of the Water Wall Turbine:

As the Water Wall Turbine can, under operational conditions, be floating on its own at a pre-determined depth, and under these conditions, it can be swiveled around its one end until the shaft is parallel to the Current and when the Turbine rotation has ceased, Maintenance can be done in safety and comfort.

Maintenance can also be done in the slack period of at High or low Tide.

In Canals the Turbine can be lifted to allow free flow of Current underneath it.

There are no rotating parts in the Water Wall Turbine therefore maintenance and maintenance costs would be low. It is foreseen that Corrosion may be the biggest Maintenance problem.

Glossary:

“Cable” will refer to any “structure”, “medium” or “method” to transfer the Current-Forces on the Blades by means of “Tensile stresses” to the Shaft.

Some examples are:
“Multi stranded tensile force bearing cable” manufactured from a practical material.
“Single “strand” Tensile-Force-bearing Profile” manufactured from an Engineering practical material.
Cast Profiles that replace, and serve the same purpose as, Multi and Single strand Cables.
Sheet Profiles (metal or other) to replace multiple Cables at a time to serve the same purpose as “Cast Profiles”.

“Current” refers to Currents such as Fresh Water Currents, Marine Currents, or any other Current such as an Air Current, etc. that moves as a result of an Energy Potential difference between two points.

“Current” means, “in general use at the present time”.

“Barrage” refers to an artificial obstruction erected across an Estuary or a River or a Marine Current, in order to influence the Tidal effect or water flow for Electricity Generation when the water levels differ across the Barrage.

“Bio-” refers to the Animal domain and Animal life that are mostly larger than Micro Organisms.

“Blade” will have the meaning of “Turbine Blade” or “Turbine vein” referring to that area of the Turbine that collects the energy from the Current.

“Blade area” refers to the area that the rotating blades described during their rotations.
With “Windmill” type Marine Turbines it would be Tr times (Blade-length) 2
With the Water Wall Turbine it would be (Blade-length) times (Vertical-Blade-depth)
“Vertical-Blade-depth” means “the maximum blade tip depth” of the bottom vertical positioned Blade under the Head.

“Blade-length” is the length of the blade radiating outwards from the Shaft.

“Blade Width” is the width of the blade measured parallel to the Shaft.

“Eco-system” maintains its normal definition.

“Energy Extraction” is the transfer of Potential Energy and/or Kinetic Energy from the Current to the Water Wall Turbine shaft.

“Energy Generation” in the context of the Turbine means “Energy Extraction for conversion into Electrical Energy”.

“Flotation” device or section refers to the three dimensional clad and sealed sections of the Blades that apart from adding to structural strength will provide floating capabilities to the Blade module.

“Harvest” will have the same meaning as “Energy Extraction”.

“Head” refers to the artificially induced Water Level Difference, across the Turbine Blades.

“Hydro Electric turbines” refers to the Turbines used in Hydro Electric Schemes in dammed up rivers or barraged water.

“Marine Turbine” refers to the “Windmill type Turbines” which are effectively submerged Wind Generator Turbines, and are currently in use for Energy Extraction from Marine Currents.

“The Water Wall Turbine” refers to our new patented Turbine Design, i.e. the rotating structure semi (less than 50%), submerged in the current, and consisting of Blades, Cables, Shaft, etc. without the Bearings, Gearbox, Alternator, etc.

“Stabilize” will have the meaning of “to give structural strength”, “to give structural stability”, in the Engineering context.

“Survive” has the meaning of being unhurt or undamaged.

“Turbine” has the normal meaning of a “cylindrical structure” that is rotated by means of an air or water current, flowing from a higher to a lower Energy Potential through the Turbine.

“Tidal zones” are those areas with high enough Tidal range for Energy Generation.

What is claimed is:

1. The Water Wall Turbine is a turbine device comprising of a Shaft, Blades and, “Structural and Power Transferring” Cables, for Economical Renewable Energy Generation from Currents such as Freshwater Currents, Marine Currents, Tidal Currents, Air Currents, etc.

2. The Water Wall Turbine as claimed in claim 1 can harvest or extract Potential and Kinetic Energy, without any dependence on barrages or “catchment ponds”.

3. The Water Wall Turbine as claimed in claim 2 can operate without Eco-unfriendly Barrages as it will generate its own Barrage effect, manifesting in the forming of a Head across the Turbine, making the Extraction of Potential Energy from the Current possible.

4. The Water Wall Turbine as claimed in 1 can operate in one or both directions for use in “Tidal zones”.

5. The Water Wall Turbine as claimed in 1 is designed so that the Construction is relatively “Low Tech”, so limited high precision machining will be required.

6. The Water Wall Turbine as claimed in 1 is designed so that no balancing, or dynamic balancing is required.

7. The Water Wall Turbine as claimed in 1 is designed so that the employment of Cables and their Power transferring properties in the structure, allows for the design and Construction of massive, but relative light, Water Wall Turbines.

8. The structural cables of the Water Wall Turbine as described and claimed in claim 7 are also used to transfer the Power exerted by the water on the Blades, to the Shaft, causing the Shaft to rotate.

9. The rotating shaft claimed in claim 8 of small (from under 1 KW) to large (multi MW) scale Turbines, provides Rotating Mechanical Energy for conversion into Electrical Energy.

10. The Water Wall Turbine as described in claim 1 can also be pre-fabricated in modular form to facilitate the easier transportation by land or floated by sea, for assembling in situ (on the site).

11. The Water Wall Turbine as claimed in claim 1 is designed for high Renewable Energy Generation in an almost 100% Eco- and Bio-friendly way by making Barrages redundant through its large blades that move safely with, and almost at the same speed but somewhat slower than the Current.

12. The Water Wall Turbine as claimed in claim 1 can also in special applications incorporate flotation sections in the Blades.

13. The Turbine as claimed in claim 1 is a Cylindrical structure that is less than 50% submerged into the current and rotates as a result of the pressure difference across the Blades caused by the Head formed by the Blades that restrictively rotate slower than the Current whilst extracting Potential Energy from the current.

14. The Turbine as claimed in claim 1 can also, when required to be extremely strong and robust, be manufactured to consist of very strong pre-cast sections that are devoid of any parts that will hook, snare or entangle debris, trees or other objects.

15. The Water Wall Turbine as claimed in claim 14 can be manufactured from any practical Engineering Material, to do away with the single or multi stranded cables without deviating from the principle of Operation and Energy Extraction employed by the Water Wall Turbine.

16. The Water Wall Turbine as claimed in claim 1 can be manufactured by replacing the “Cables” with any practical Engineering Material in “Sheet Profile” form, to do away with the single or multi stranded cables, avoiding thereby any parts that will hook, snare or entangle debris, trees or other objects.

17. The Water Wall Turbine as claimed in 1 is positioned with the Shaft and Blades perpendicular to the Current flow, and therefore the Peripheral speed of the Water Wall Turbine rotating in the direction of the water flow, will be almost the same but slower than Water speed under operational conditions, resulting in absolute Bio-friendly operation.

18. This unique positioning and application of the Water Wall Turbine as claimed in claim 16 is in order to act as a “wall” confronting the Current, allowing for a higher Energy Extraction and Yield from the Current than Turbines with blades rotating in a plane, perpendicular to the Current direction.

19. This unique positioning and application of the Water Wall Turbine as claimed in claim 13, allows for all interactive and rotating parts used with the Turbine such as the Bearings, Gearbox, Alternator, etc. to be effectively well above the water level in order to eliminate submersed “pressure sealing problems”.

20. The Water Wall Turbine as claimed in claim 1 is able to Extract Energy from shallow but fast flowing Currents.

21. The Water Wall Turbine as claimed in claim 1 is able to Extract Energy from Tidal Currents that varies from Zero meter depth, to 20 m plus during the Tidal cycles.

22. The Water Wall Turbine as claimed in claim 1 can be pre-fabricated in Modular form so it can be easily transferred to the site by land, or floated by sea by means of the Flotation Chambers, so it can be assembled in situ with minimum ecological damage.

23. The Shaft as claimed in claim 8 comprises normally of a part of the modular Blade section, and forms the shaft when all Modular sections are bound together, but it can be a separate structure or tube.
